(19) United States
(12) Patent Application Publication
(10) Pub. No.: US 2013/0229582 A1
(43) Pub. Date: Sep. 5, 2013

(54) SYSTEM AND METHOD FOR CONTROLLING A DEVICE

(71) Applicant: O2MICRO INC., Santa Clara, CA (US)

(72) Inventors: Sterling Shyundii Du, Shanghai (CN); Weitai Yang, Shanghai (CN)

(73) Assignee: O2MICRO INC., Santa Clara, CA (US)

(21) Appl. No.: 13/756,609

(22) Filed: Feb. 1, 2013

(30) Foreign Application Priority Data
Mar. 1, 2012 (CN) 201210051531.4

(51) Int. Cl. H04N 5/44

(52) U.S. Cl. CPC H04N 5/4403
USPC 348/734

(57) ABSTRACT

A control system of a device is disclosed. The control system comprises an acquisition module, an identification module, a determining module and a control module. The acquisition module is configured for detecting whether there are one or more users present in a predetermined area before a device, and obtaining characteristic information of the one or more detected users. The identification module is configured for detecting the identity of each of the one or more users by comparing the characteristic information of the one or more users with stored characteristic information. The determining module is configured for determining priority and/or authority of each of the one or more users based on the identity of each of the one or more users, and determining an operator based on the authority and/or priority. The control module is configured for controlling the device based on at least one instruction of the operator.

### RELATED APPLICATIONS

This application claims priority to Chinese Patent Application No. 201210051531.4, filed on Mar. 1, 2012 with the State Intellectual Property Office of the People's Republic of China, incorporated by reference in its entirety herein.

### FIELD OF THE PRESENT TEACHING

The present teaching relates generally to a field of device controlling technology, specifically to a system and a method for controlling an electronic device.

### BACKGROUND

With the development of information technology, televisions have been equipped with user interfaces (UI) or operating systems (OS). This enables users to control the television by speech or body-movement. However, if there are two or more users present before the television at the same time, the television may not be able to recognize each user's control instruction and response correctly.

### SUMMARY

The embodiments described herein relate to methods and systems for controlling a device.

In an embodiment, a control system of a device is disclosed. The control system includes an acquisition module, an identification module, a determining module and a control module. The acquisition module is configured for detecting whether there are one or more users present in a predetermined area before a device, and obtaining characteristic information of the one or more detected users. The identification module is configured for detecting the identity of each of the one or more users by comparing the characteristic information of the one or more users with stored characteristic information. The determining module is configured for determining priority and/or authority of each of the one or more users based on the identity of each of the one or more users, and determining an operator based on the authority and/or priority of each of the one or more users. The control module is configured for controlling the device based on at least one instruction of the operator, wherein the at least one instruction is detected with respect to the operator.

In another embodiment, a method for controlling a device is disclosed. The method includes detecting whether there are one or more users present in a predetermined area before the device. Then, characteristic information of the one or more users is obtained. The obtained characteristic information of the one or more users is compared with stored characteristic information. An identity and corresponding priority and/or authority of each of the one or more users are determined. Then an operator is determined based on the authority and/or priority of each user. At least one instruction with respect to the operator is detected. The device is controlled based on the detected at least one instruction of the operator.

In yet another embodiment, a device is disclosed. The device includes a control system. The control system is configured to detect whether there are one or more users present in a predetermined area before the device. The control system is also configured to obtain characteristic information of the one or more users. The control system is also configured to compare the obtained characteristic information of the one or more users with stored characteristic information. The control system is also configured to determine an identity and corresponding priority and/or authority of each of the one or more users. The control system is also configured to determine an operator based on the authority and/or priority of each user. The control system is also configured to detect at least one instruction with respect to the operator and control the device based on the detected at least one instruction of the operator.

Additional benefits and novel features will be set forth in part in the description which follows, and in part will become apparent to those skilled in the art upon examination of the following and the accompanying drawings or may be learned by production or operation of the disclosed embodiments. The benefits of the present embodiments may be realized and attained by practice or use of various aspects of the methodologies, instrumentalities and combinations set forth in the detailed description set forth below.

### BRIEF DESCRIPTION OF THE DRAWINGS

Features and benefits of embodiments of the claimed subject matter will become apparent as the following detailed description proceeds, and upon reference to the drawings, wherein like numerals depict like parts. These exemplary embodiments are described in detail with reference to the drawings. These embodiments are non-limiting exemplary embodiments, in which like reference numerals represent similar structures throughout the several views of the drawings.

FIG. 1 illustrates a block diagram of a control system of a device, in accordance with an embodiment of the present teaching;

FIG. 2 illustrates a block diagram of a determining module in FIG. 1, in accordance with an embodiment of the present teaching;

FIG. 3 illustrates a block diagram of a control module in FIG. 1, in accordance with an embodiment of the present teaching;

FIG. 4 illustrates a block diagram of a control system of a device, in accordance with another embodiment of the present teaching;

FIG. 5 illustrates a block diagram of a device, in accordance with an embodiment of the present teaching;

FIG. 6 is a flowchart illustrating a method for controlling a device, in accordance with an embodiment of the present teaching;

FIG. 7 is a flowchart illustrating a method for controlling a device, in accordance with another embodiment of the present teaching;

FIG. 8 is a flowchart illustrating determining an operator in FIG. 7, in accordance with an embodiment of the present teaching;

FIG. 9 is a flowchart illustrating controlling a device based on instructions of an operator and managing characteristic information and recognizable instructions in FIG. 7, in accordance with an embodiment of the present teaching; and

FIG. 10 depicts a general computer architecture on which the present teaching can be implemented.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth in order to provide a thorough understanding of the present teaching. However, it will be recognized by one of ordinary skill in the art that the present teaching may be practiced without these specific details. In other instances, well known methods, procedures, components, and circuits have not been described in detail as not to unnecessarily obscure aspects of the present teaching.

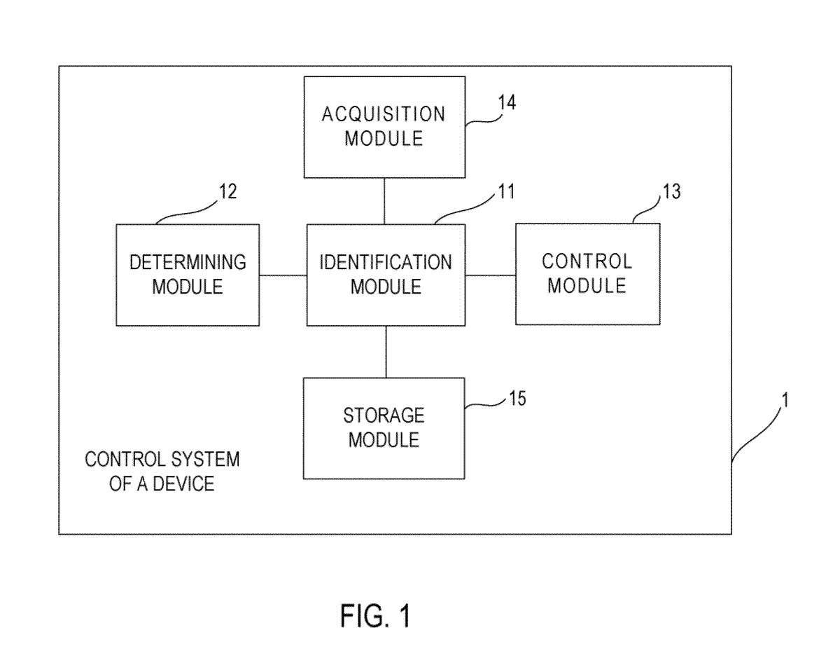

FIG. 1 illustrates a block diagram of a control system 1 of a device, in accordance with an embodiment of the present teaching. As shown in FIG. 1, the control system 1 includes an identification module 11, a determining module 12, a control module 13, an acquisition module 14 and a storage module 15.

In this exemplary embodiment, the acquisition module 14 is configured for detecting whether there are one or more users present in a predetermined area before the device and obtaining characteristic information of the one or more detected users. The acquisition module 14 is also configured for transmitting the characteristic information of the one or more users to the identification module 11, in this exemplary embodiment. The identification module 11 is configured for detecting the identity of each of the one or more users, by comparing the characteristic information of the one or more users with stored characteristic information in the storage module 15. The determining module 12 is configured for determining authority and/or priority of each of the one or more users based on the identity of each of the one or more users and determining an operator based on the authority and/or priority of each of the one or more users. The acquisition module 14 is also configured to detect at least one instruction with respect to an operator and transmit the at least one instruction to the control module 13. The control module 13 is configured for controlling the device based on the at least one instruction of the operator.

In an exemplary embodiment, the acquisition module 14 includes a camera and a microphone coupled to the identification module 11 to detect the characteristic information of the user. The camera may detect facial information of a user, and the microphone may detect speech information of a user. The facial information may be detected by a facial image.

In an exemplary embodiment, the storage module 15 is configured to store characteristic information of at least one user and one or more recognizable instructions. The stored characteristic information of a user may include a user name, a user identification, a stored facial information, stored speech information, authority and priority of the user. The facial information may be carried by a facial image. The authority of the user may further include the number and the type of allowable watching programs, allowable watching period and a predetermined threshold for an upper limit of allowable watching time. The higher priority the user has, the more authorities are given to the user. The stored one or more recognizable instructions may include stored speech instructions and stored body-movement instructions. The stored speech instructions may include sentences such as “change the channel”, “turn up the volume” and “increase the contrast ratio” to instruct a device to perform corresponding operations. The stored body-movement instructions may include gestures such as waving hands or nodding.

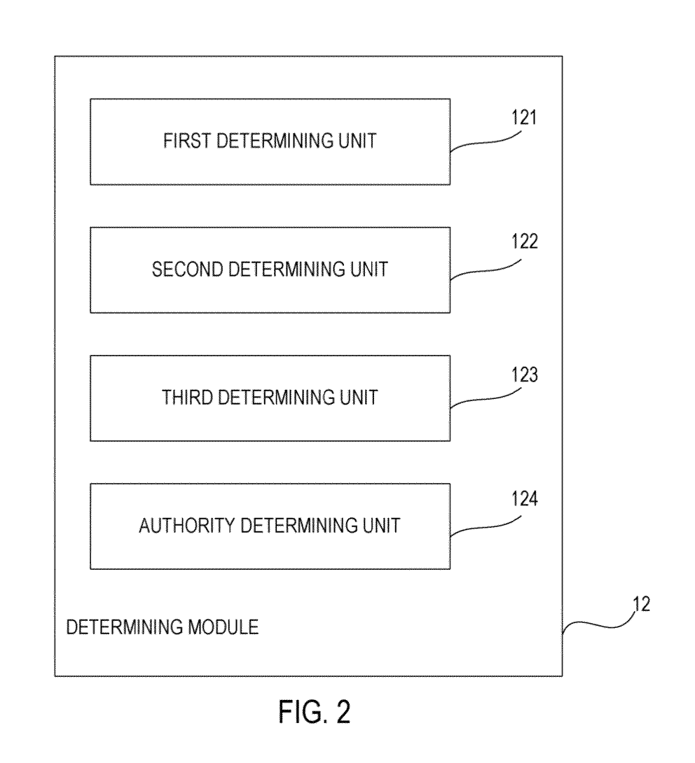

FIG. 2 illustrates a block diagram of a determining module 12 in FIG. 1, in accordance with an embodiment of the present teaching. The determining module 12 in this exemplary embodiment includes a first determining unit 121, a second determining unit 122, a third determining unit 123 and an authority determining unit 124.

In an exemplary embodiment, the acquisition module 14 scans in a predetermined area before the device to check whether there are one or more users present. If there are one or more users present in the predetermined area, the acquisition module 14 detects characteristic information of the one or more users. The identification module 11 is configured to identify whether there is at least one detected user whose characteristic information has been stored in the storage module 15, by comparing the characteristic information of the one or more detected users with stored characteristic information. If there is at least one detected user whose characteristic information has been stored in the storage module 15, the first determining unit 121 in the determining module 12 sets a user with a highest priority as an operator. In some exemplary embodiments, if there are at least two detected users who have the highest priority, the second determining unit 122 sets a user whose highest priority is first detected as an operator. If there is no characteristic information stored in the storage module 15 for any of the one or more detected users, the third determining unit 123 sets a user who is first detected among the one or more users as an operator. The authority determining unit 124 determines the authority and/or the priority of the user based on the identity of each user detected by the identification module 11. In one exemplary embodiment, the identification module 11 compares detected facial information with stored facial information, or compares detected speech information with stored speech information to recognize the user. Then the authority determining unit 124 retrieves corresponding authority and/or priority of each detected user from the storage module 15.

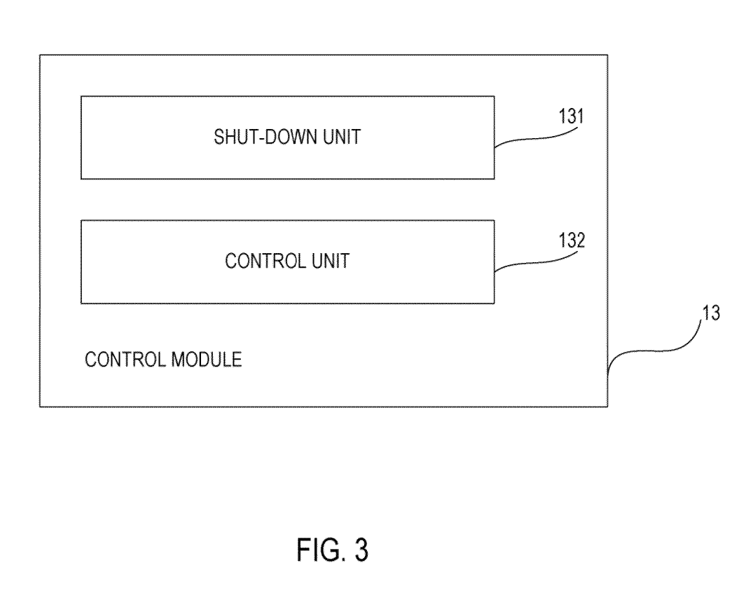

FIG. 3 illustrates a block diagram of a control module 13 in FIG. 1, in accordance with an embodiment of the present teaching. The control module 13 includes a shut-down unit 131 and a control unit 132.

After determining an operator, the determining module 12 in FIG. 1 determines whether the operator is a limited user based on the stored characteristic information of the operator. If the operator is a limited user, the determining module 12 further determines whether accumulated watching time of the operator in one day reaches a predetermined threshold, e.g., an upper limit of allowable watching time, and whether current time period is within an allowable watching period. If the accumulated watching time of the operator in one day reaches the predetermined threshold, or current time period is not within an allowable watching period, the shut-down unit 131 controls the device to shut down. Otherwise, if the operator is not a limited user, or if the operator is a limited user and the accumulated watching time of the operator in one day does not reach the predetermined threshold and the current time is within the allowable watching period, the control unit 132 performs corresponding processes once at least one recognizable instruction from the operator is detected. The at least one recognizable instruction may include at least one of a speech instruction and a body-movement instruction.

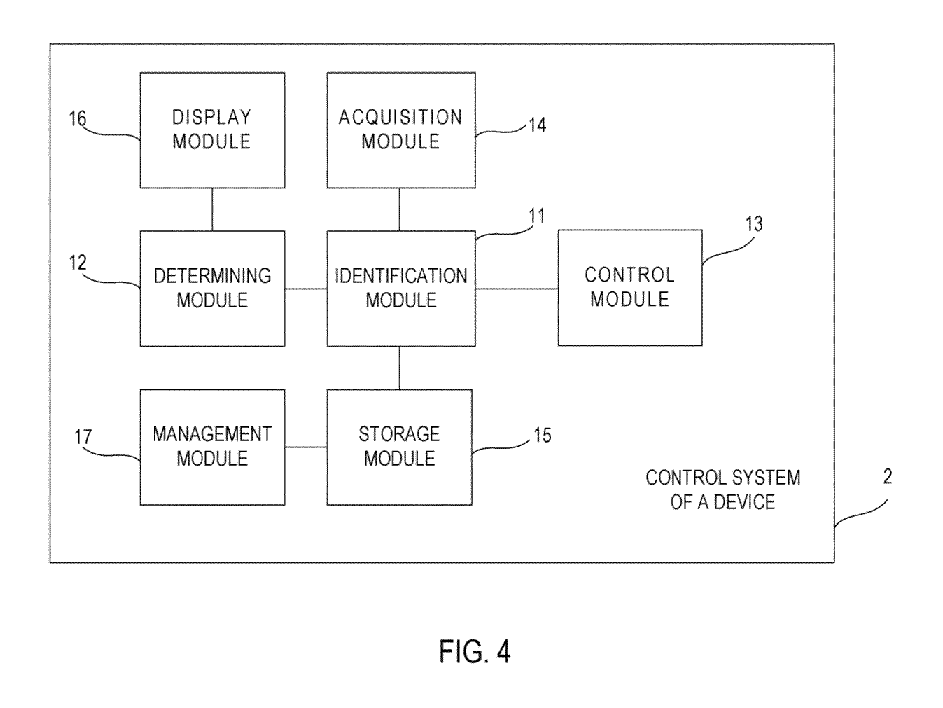

FIG. 4 illustrates a block diagram of a control system 2 of a device, in accordance with another embodiment of the present teaching. Elements labeled the same as in FIG. 1 have similar functions. Compared with the control system 1 in FIG. 1, the control system 2 further includes a display module 16 and a management unit 17.

In this exemplary embodiment, after determining an operator by the determining module 12, the display module 16 displays an identification, e.g., a stored facial information or a stored facial image, of the operator on an screen of the device to inform the one or more users who is the operator. The management module 17 manages stored characteristic information and stored one or more recognizable instruction based on at least one detected instruction of the operator.

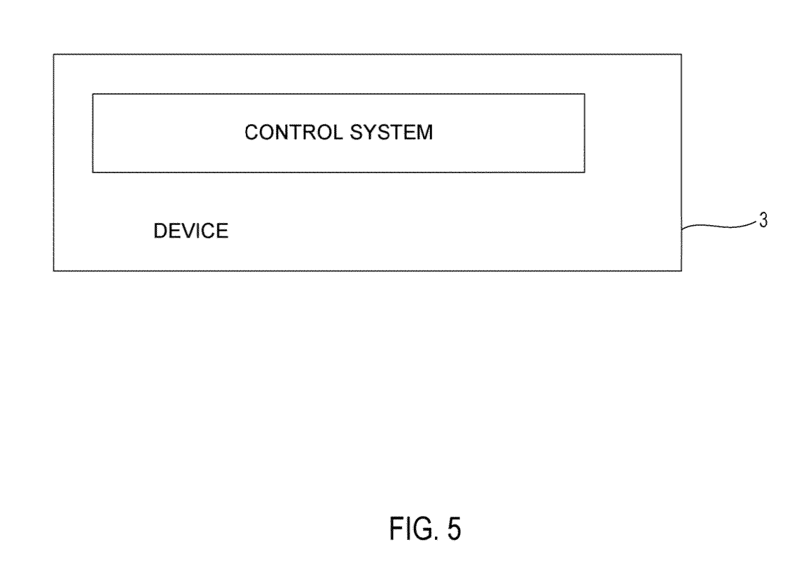

FIG. 5 illustrates a block diagram of a device 3, in accordance with an embodiment of the present teaching. The device 3 may include a control system 1 illustrated in FIG. 1 or a control system 2 illustrated in FIG. 4. In some exemplary embodiments, the device 3 may be an electronic device including a processor and a storage. In some exemplary embodiments, the device 3 may be a television.

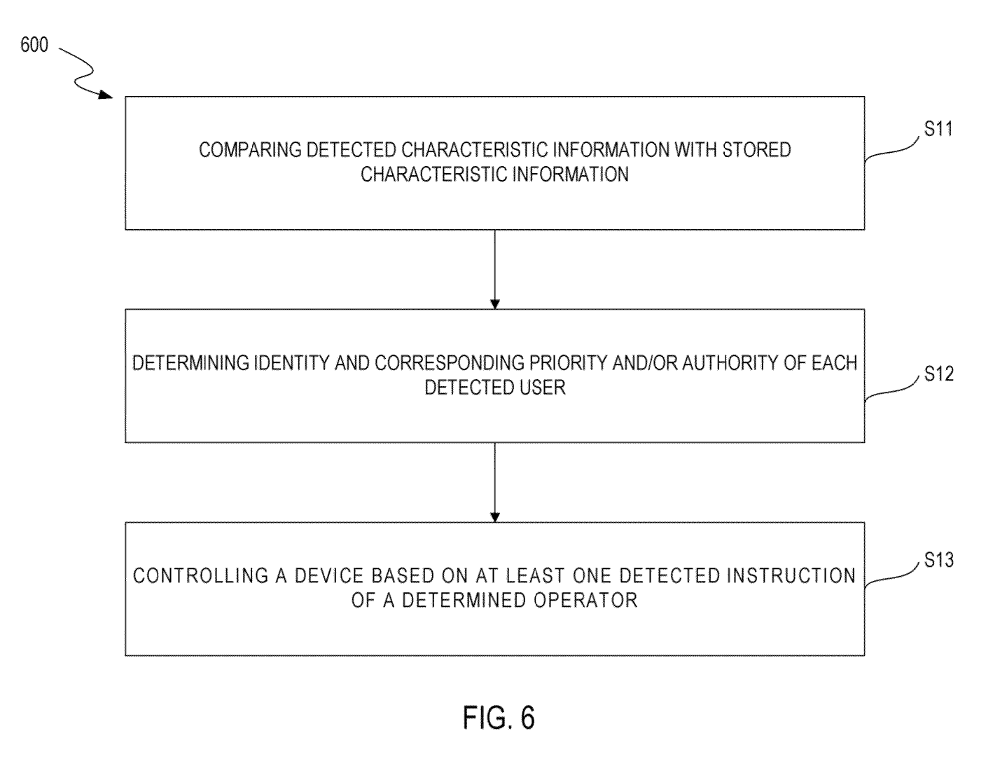

FIG. 6 is a flowchart 600 illustrating a method for controlling a device, in accordance with an embodiment of the present teaching. In accordance with some exemplary embodiments, FIG. 6 may be described in combination with FIG. 1.

At S11, characteristic information of one or more detected users is compared with stored characteristic information. As described above, S11 may be performed by, e.g., the identification module 11 of the control system 1 of the device. The one or more users may be detected to be present in a predetermined area before the device.

At S12, identity and priority and/or authority of each of the one or more detected users are determined based on the comparison result. As described above, S12 may be performed by, e.g., the determining module 12 of the control system 1 of the device. Then the determining module 12 may determine an operator.

At S13, the device is controlled based on at least one detected instruction of the operator. As described above. S13 may be performed by, e.g., the control module 13 of the control system 1 of the device.

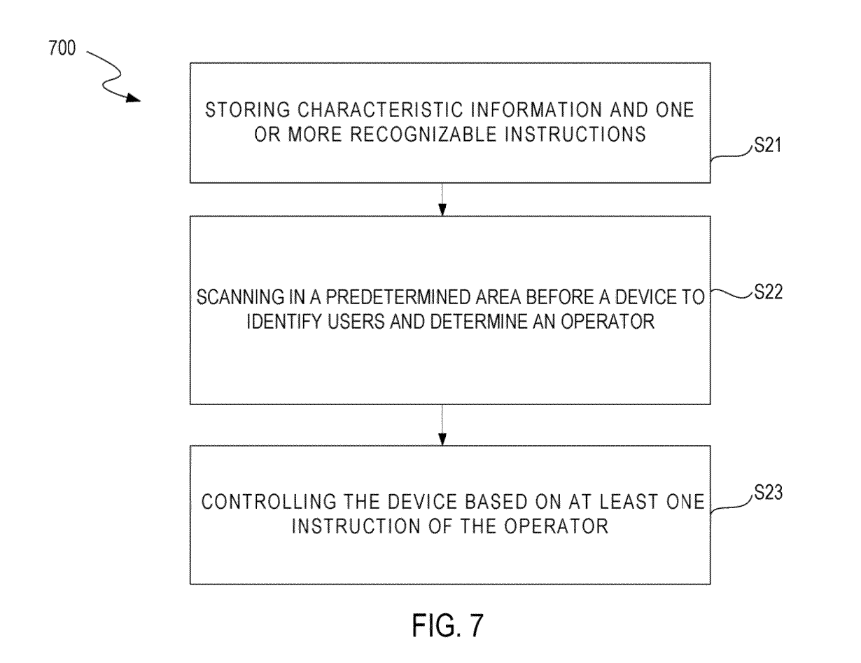

FIG. 7 is a flowchart 700 illustrating a method for controlling a device, in accordance with another embodiment of the present teaching. In accordance with some exemplary embodiments, FIG. 7 may be described in combination with FIG. 4.

At S21, characteristic information and one or more recognizable instructions are stored, e.g., in a storage module 15 of the control system 2 of the device.

At S22, after powering up the device, one or more users are identified by scanning in a predetermined area before the device. As described above, S22 can be performed by, for example, the acquisition module 14 and the identification module 11 in the control system 2 of the device. An operator is then determined by, for example, the determining module 12 in the control system 2 of the device.

At S23, the device is controlled based on at least one detected instruction of the operator, by for example, the control module 13 in the control system 2 of the device. The stored characteristic information and stored one or more recognizable instructions are managed by for example, the management module 17 in the control system 2 of the device.

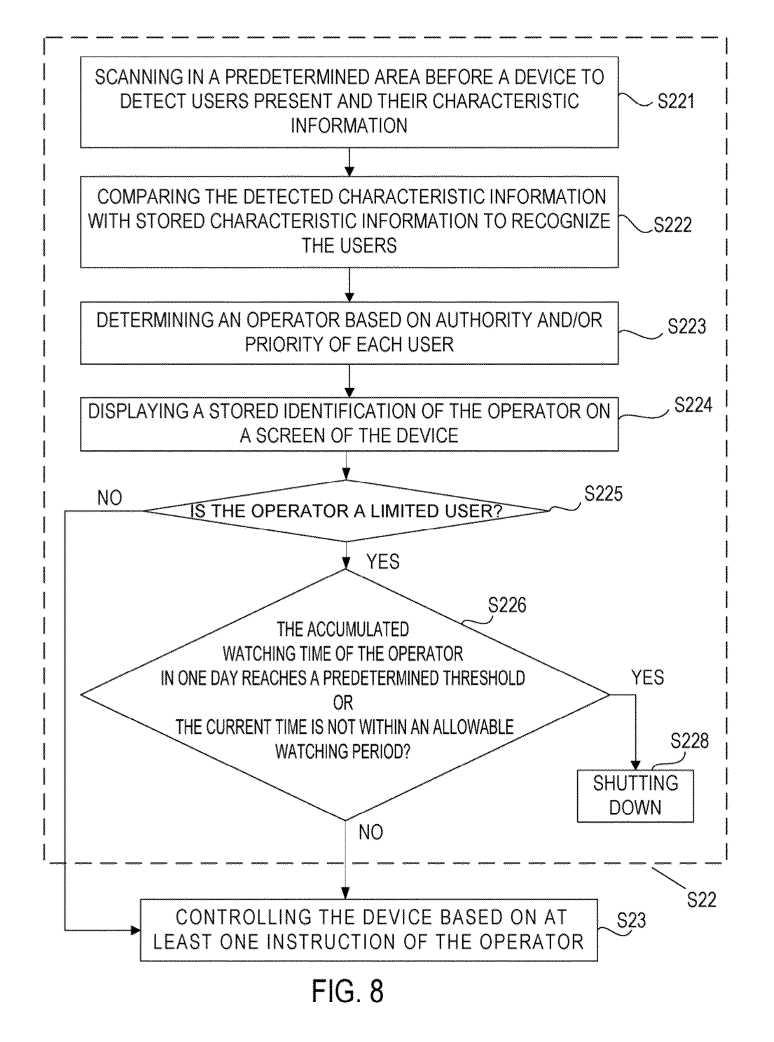

More specifically, FIG. 8 illustrates a method for determining an operator S22 shown in FIG. 7. In accordance with some exemplary embodiments. FIG. 8 may be described in combination with FIG. 4.

At S221, an acquisition module 14 in the control system 2 of the device, for example, scans in a predetermined area before the device to check whether there are one or more users present. If there are users present in the predetermined area, the acquisition module 14 detects characteristic information of each user of the detected users and transmits detected characteristic information to, for example, an identification module 11 in the control system 2 of the device. The detected characteristic information includes detected facial information and/or detected speech information. If there is no user present in the predetermined area, the acquisition module 14 waits for a predetermined time and starts scanning again.

At S222, the detected characteristic information is compared with stored characteristic information in e.g., a storage module 15 in the control system 2 of the device to recognize the users. As described above, S222 can be performed by, for example, the identification module 11 in the control system 2 of the device.

At S223, authority and/or priority of each user is determined based on the comparison result at S222. Then an operator is determined based on authority and/or priority of each user. As described above, S223 can be performed by, for example, the determining module 12 in the control system 2 of the device.

More specifically, the control system may identify a user by comparing the detected speech information with stored speech information or by comparing the detected facial images with stored facial images.

If there are at least one detected user whose characteristic information is previously stored in the storage module 15, the determining module 12 sets a user with a highest priority as an operator.

If there are at least two detected users who have the highest priority, the determining module 12 sets a user whose highest priority is first detected as an operator.

If there is no characteristic information stored previously in the storage module 15 for any of detected users, the determining module 12 sets a user who is first detected among the one or more users as an operator.

After determining an operator, the acquisition module 14 keeps scanning in a low power consumption mode to save power. If any speech information or body movement information is detected, the acquisition module 14 switches to a normal mode.

At S224, after determining an operator, an identification, e.g., a stored facial image of the operator is displayed on the screen of the device to inform the users who is the operator. Then the operator can control the device by speech or body movement. As described above, S224 can be performed by, for example, the display module 16 in the control system 2 of the device.

At S225, the determining module 12 in the control system 2 of the device, e.g., further determines whether the operator is a limited user based on the stored characteristic information. If the operator is a limited user, the method proceeds to S226. Otherwise, the method proceeds to S23. In one exemplary embodiment, children and old people are labeled as limited users to restrict the dependency on device.

At S226, the determining module 12, e.g., determines if the accumulated watching time of the operator accumulated in one day reaches a predetermined threshold, e.g., an upper limit of allowable watching time or if the current time is not within an allowable watching period? If either one of the answer is yes, the method moves to S228. Otherwise, the method proceeds to the S23.

In one exemplary embodiment, the device is a television, and may store characteristic information of a family including parents with highest and first priorities, grand parents with second priorities, and kids with lowest and third priorities. Friends of the family may also have characteristic information stored in the device. The first priorities may include rights to watch all channels in any time period, and rights to set up any parameters of the television, and rights to control their own watching time period. The second priorities may include rights to watch limited and predetermined channels of the television in a predetermined time period. The lowest priorities may include rights to watch more limited channels in more limited time period.

At S228, device is shut down, by e.g., the control module 13 in the control system 2 of the device.

As described above, at S23, the device is controlled based on at least one detected instruction of the operator, by for example, the control module 13 in the control system 2 of the device.

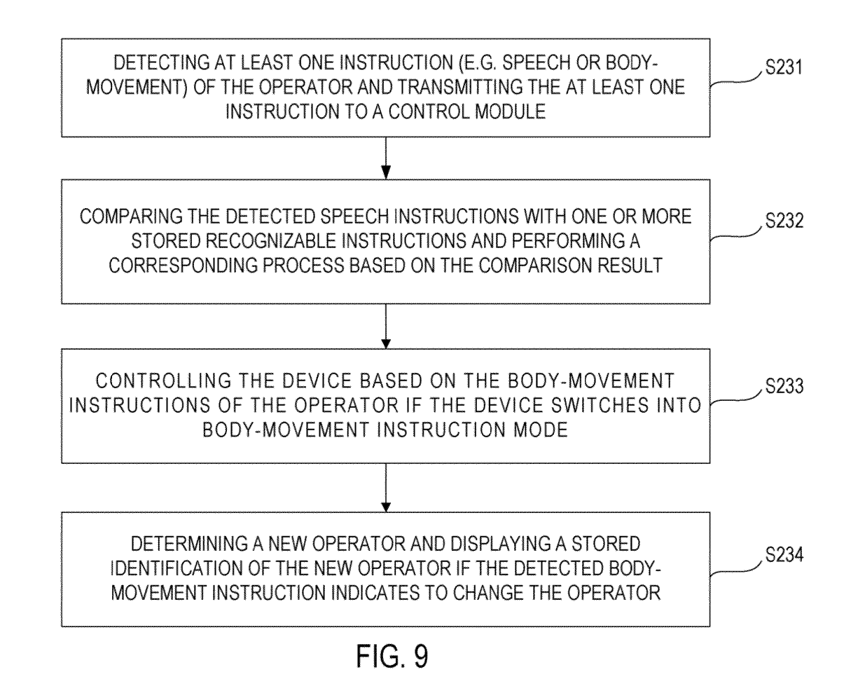

More specifically, FIG. 9 illustrates a method for controlling the device S23 in FIG. 7. In accordance with some exemplary embodiments, FIG. 9 may be described in combination with FIG. 4.

At S231, at least one instruction of the operator is detected and transmitted to e.g., the control module 13 in the control system 2 of the device. As described above, S231 may be performed by, e.g. the acquisition module 14 in the control system 2 of the device. The detected at least one instruction of the operator may include at least one of a detected speech instruction and a detected body-movement instruction. In one exemplary embodiment, in a default setting, the control module 13 controls the device based on the detected speech instructions with higher priorities than the detected body-movement instructions of the operator.

At S232, the detected speech instructions are compared with one or more stored recognizable instructions and a corresponding process is performed based on the comparison result. As described above, S232 may be performed by, e.g., the control module 13 in the control system 2 of the device.

In some exemplary embodiments, the method may include, but not limit to, powering on and shutting down the device, switching the channel and setting parameters, e.g., volume, brightness, contrast, or resolution.

For example, if the device recognizes the speech instruction as “switch the channel”, the device switches the channel according to the instruction. Moreover, in one exemplary embodiment, the device can switch to a certain channel directly. Thus the operator does not need to remember the number of the channel or to switch the channel in sequence. If the device recognizes the speech instruction as “shut down”, the device is shut down according to the instruction.

At S233, if the device switches into body-movement instruction mode, the control module 13 in the control system 2 of the device controls the device based on the body movement instructions of the operator.

In some exemplary embodiments, if the operator does not like to talk or is in a situation that is not convenient to talk, the operator can control the device by body movements. For example, the operator controls the device to switch into movement-instruction mode by waving a hand horizontally. For example, the operator controls the device to switch the channel by waving a hand vertically or nodding. More specifically, a camera may record a dynamic track of the body movements of the operator. The device compares the recorded body movement track with stored body movement track to recognize the body-movement instruction and performs a corresponding process.

Furthermore, in some exemplary embodiments, the operator can indicate to change the operator to another user by a speech instruction or a body-movement instruction if the operator wants to leave.

At S234, if the control module 13 recognizes that an instruction of the operator indicates to change the operator, the device determines a new operator based on the instruction and displays the identification, e.g., the stored facial image, of the new operator on the screen of the device.

In one exemplary embodiment, the current operator can assign the control right to a new operator by naming out the new operator. The device recognizes a speech instruction by comparing a heard username with stored usernames and switches the control right to the new operator after recognizing the speech instruction. In another exemplary embodiment, the current operator can assign the control right to a new operator by pointing to the new operator. The device recognizes the body-movement instruction and switches the control right to the new operator.

In some exemplary embodiments, if the current operator leaves without assigning the control right to others, the acquisition module 14 may inform the device to assign the control right to a new operator after detecting that the current operator has been absent for a predetermined time.

The managements of stored characteristic information and stored one or more recognizable instructions may include adding or deleting stored characteristic information and stored one or more recognizable instructions.

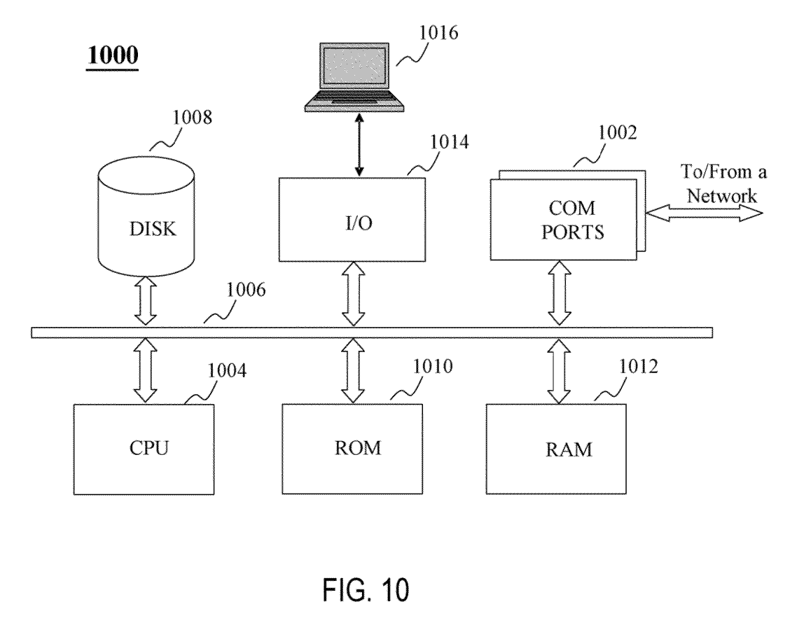

FIG. 10 depicts a general computer architecture on which the present teaching can be implemented and has a functional block diagram illustration of a computer hardware platform that includes user interface elements. The computer may be a general-purpose computer or a special purpose computer. This computer 1000 can be used to implement any components of the distributed application stack deployment architecture as described herein. Different components of the control system 1 and/or 2, e.g., as depicted in FIGS. 1 and 4, can all be implemented on one or more computers such as computer 1000, via its hardware, software program, firmware, or a combination thereof. Although only one such computer is shown, for convenience, the computer functions relating to dynamic relation and event detection may be implemented in a distributed fashion on a number of similar platforms, to distribute the processing load.

The computer 1000, for example, includes COM ports 1002 connected to and from a network connected thereto to facilitate data communications. The computer 1000 also includes a central processing unit (CPU) 1004, in the form of one or more processors, for executing program instructions. The exemplary computer platform includes an internal communication bus 1006, program storage and data storage of different forms, e.g., disk 1008, read only memory (ROM) 1010, or random access memory (RAM) 1012, for various data files to be processed and/or communicated by the computer, as well as possibly program instructions to be executed by the CPU. The computer 1000 also includes an I/O component 1014, supporting input/output flows between the computer and other components therein such as user interface elements 1016. The computer 1000 may also receive programming and data via network communications.

Hence, aspects of the method of controlling a device, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution e.g., an installation on an existing server. In addition, the units of the host and the client nodes as disclosed herein can be implemented as a firmware, firmware/software combination, firmware/hardware combination, or a hardware/firmware/software combination.

While the foregoing description and drawings represent embodiments of the present teaching, it will be understood that various additions, modifications and substitutions may be made therein without departing from the spirit and scope of the principles of the present teaching as defined in the accompanying claims. One skilled in the art will appreciate that the teaching may be used with many modifications of form, structure, arrangement, proportions, materials, elements, and components and otherwise, used in the practice of the teaching, which are particularly adapted to specific environments and operative requirements without departing from the principles of the present teaching. The presently disclosed embodiments are therefore to be considered in all respects as illustrative and not restrictive, the scope of the teaching being indicated by the appended claims and their legal equivalents, and not limited to the foregoing description.

We claim:

1. A control system comprising:
an acquisition module configured for
detecting whether there are one or more users present in a predetermined area before a device, and
obtaining characteristic information of the one or more detected users;
an identification module configured for detecting the identity of each of the one or more users by comparing the characteristic information of the one or more users with stored characteristic information;
a determining module configured for
determining priority and/or authority of each of the one or more users based on the identity of each of the one or more users, and
determining an operator based on the authority and/or priority of each of the one or more users; and
a control module configured for controlling the device based on at least one instruction of the operator, wherein the at least one instruction is detected with respect to the operator.

2. The control system of claim 1, wherein the determining module comprises:
a first determining unit configured to set one of the one or more users with a highest priority as the operator if there is at least one of the one or more users whose characteristic information is previously stored;
a second determining unit configured to set a user whose highest priority is first detected as the operator if there are at least two detected users who have the highest priority; and
a third determining unit configured to set a user who is first detected among the one or more users as the operator if there is no characteristic information previously stored for any of the one or more users.

3. The control system of claim 1, wherein the control module comprises:
a shut-down unit configured to shut down the device if the operator is a limited user, and if accumulated watching time of the operator in one day reaches a predetermined threshold or current time period is not within an allowable watching period; and
a control unit configured to compare the at least one instruction with one or more stored recognizable instructions to recognize the at least one instruction and control the device based on the at least one instruction if the operator is not a limited user, or if the operator is a limited user and the accumulated watching time of the operator in one day does not reach the predetermined threshold and the current time is within the allowable watching period,
wherein the at least one instruction includes at least one of a speech instruction and a body-movement instruction.

4. The control system of claim 3, wherein the control system further comprises:
a storage module configured to store the characteristic information and the one or more recognizable instructions,
wherein the stored characteristic information comprises user names, user identifications, stored facial information, stored speech information, authorities and priorities, and wherein the stored one or more recognizable instructions comprise stored speech instructions and stored body-movement instructions.

5. The control system of claim 4, wherein the control system further comprises:
a display module configured to display the identification of the operator after determining the operator by the determining module; and
a management module configured to manage the stored characteristic information and the one or more stored recognizable instructions based on the e t one instruction of the operator.

6. The control system of claim 1; wherein
the characteristic information includes at least one of facial information and speech information; and
the determining module further comprises an authority determining unit configured to retrieve the authority and/or the priority of each of the one or more users from the storage module.

7. A method for controlling a device, comprising:
detecting whether there are one or more users present in a predetermined area before the device;
obtaining characteristic information of the one or more users;
comparing the obtained characteristic information of the one or more users with stored characteristic information;
determining an identity and corresponding priority and/or authority of each of the one or more users;
determining an operator based on the authority and/or priority of each user;
detecting at least one instruction with respect to the operator; and
controlling the device based on the detected at least one instruction of the operator.

8. The method of claim 7, wherein the characteristic information includes at least one of facial information and speech information.

9. The method of claim 7, further comprising:
setting one of the one or more users with a highest priority as the operator if there is at least one of the one or more users whose characteristic information is previously stored;
setting a user whose highest priority is first detected as the operator, if there at least two detected users who have the highest priority; and
setting a user who is first detected among the one or more users as the operator, if there is no characteristic information stored previously for any of the one or more users.

10. The method of claim 7, further comprising:
shutting down the device if the operator is a limited user, and if accumulated watching time of the operator in one day reaches a predetermined threshold or current time period is not within an allowable watching period;
comparing the at least one instruction with one or more stored recognizable instructions to recognize the at least one instruction; and
controlling the device based on the at least one instruction if the operator is not a limited user, or if the operator is a limited user and the accumulated watching time of the operator in one day does not reach the predetermined threshold and the current time is within the allowable watching period,
wherein the at least one instruction includes at least one of a speech instruction and a body-movement instruction.

11. The method of claim 10, further comprising:
storing the characteristic information and the one or more recognizable instructions.

12. The method of claim 7, wherein the stored characteristic information comprises user names, user identifications, stored facial information, stored speech information, authorities and priorities, and wherein the stored one or more recognizable instructions comprise stored speech instructions and stored body-movement instructions.

13. The method of claim 7, wherein determining an identity and corresponding priority and/or authority of each of the one or more users further comprising:
retrieving the authority and/or the priority of each of the one or more users from a storage module.

14. The method of claim 12, further comprising:
displaying the identification of the operator after determining the operator.

15. The method of claim 11, further comprising:
managing the stored characteristic information and the one or more stored recognizable instructions based on the at least one instruction of the operator.

16. A device comprising a control system, wherein the control system is configured to
detect whether there are one or more users present in a predetermined area before the device;
obtain characteristic information of the one or more users;
compare the obtained characteristic information of the one or more users with stored characteristic information;
determine an identity and corresponding priority and/or authority of each of the one or more users;
determine an operator based on the authority and/or priority of each user;
detect at least one instruction with respect to the operator; and
control the device based on the detected at least one instruction of the operator.

17. The device of claim 16, wherein the control system is further configured to:
set one of the one or more users with a highest priority as the operator if there is at least one of the one or more users whose characteristic information is previously stored;
set a user whose highest priority is first detected as the operator, if there are at least two detected users who have the highest priority; and
set a user who is first detected among the one or more users as the operator, if there is no characteristic information stored previously for any of the one or more users.

18. The device of claim 16, wherein the control system is further configured to:
shut down the device if the operator is a limited user, and if accumulated watching time of the operator in one day reaches a predetermined threshold or current time period is not within an allowable watching period;
compare the at least one instruction with one or more stored recognizable instructions to recognize the at least one instruction; and
control the device based on the at least one instruction if the operator is not a limited user, or if the operator is a limited user and the accumulated watching time of the operator in one day does not reach the predetermined threshold and the current time is within the allowable watching period,
wherein the at least one instruction includes at least one of a speech instruction and a body-movement instruction.

19. The device of claim 18, wherein the control system is further configured to:
store the characteristic information and the one or more recognizable instructions.

20. The device of claim 16, wherein the stored characteristic information comprises user names, user identifications, stored facial information, stored speech information, authorities and priorities, and wherein the stored one or more recognizable instructions comprise stored speech instructions and stored body-movement instructions.

21. The device of claim 16, wherein the control system is further configured to:
retrieve the authority and/or the priority of each of the one or ore users from a storage module.

22. The device of claim 20, wherein the control system is further configured to:
display the identification of the operator after determining the operator.

23. The device of claim 19, wherein the control system is further configured to:
manage the stored characteristic information and the stored one or more recognizable instructions based on the at least one instruction of the operator.
